(19) United States
(12) Patent Application Publication
(10) Pub. No.: US 2014/0183036 A1
(43) Pub. Date: Jul. 3, 2014

(54) In Situ Sputtering Target Measurement

(71) Applicant: INTERMOLECULAR, INC., San Jose, CA (US)

(72) Inventors: ShouQian Shao, Fremont, CA (US); Kent Riley Child, Dublin, CA (US); Jingang Su, Cupertino, CA (US)

(73) Assignee: Intermolecular, Inc., San Jose, CA (US)

(21) Appl. No.: 13/728,096

(22) Filed: Dec. 27, 2012

(51) Int. Cl. G01B 11/24

(52) U.S. Cl. CPC G01B 11/24
USPC 204/192.13; 204/298.03

(57) ABSTRACT

Methods and systems for in situ measuring sputtering target erosion are disclosed. The emission of material from the sputtering target is stopped, a distance sensor is scanned across a radial line on the sputtering target. The sputtering chamber contains a controlled environment separate and distinct from the environment outside the chamber, and the controlled environment is maintained during the scanning The resulting distance data is converted into a surface profile of the sputtering target. The accuracy of the surface profile can be less than about ±1 μm. The distance sensor is protected from deposition of the material from the sputtering target. End-of-life for a sputtering target can be determined by obtaining a surface profile of the sputtering target at regular intervals and replacing the sputtering target when the thinnest location on the target as measured by the surface profile is below a predetermined threshold.

### FIELD OF THE INVENTION

One or more embodiments of the present invention relate to physical vapor deposition by sputtering.

### BACKGROUND

A commonly used method in semiconductor processing is physical vapor deposition where sputtered material provided from a sputtering target is deposited on a substrate. Over the course of time, the sputtering target is eroded, and eventually the target must be replaced. A typical sputtering source uses a magnetron to generate a plasma which erodes the target. Typically, maximum erosion occurs in a ring, and the target must be replaced before the target thins excessively in that ring.

In production use, the same sputtering parameters are used repeatedly, and target life can be accurately predicted based on prior experience. In these situations, it may be adequate to replace targets based on hours of use. However, when sputtering targets are used in a research and development environment, parameters may be varied from run to run, and it can be very difficult to estimate remaining target life even if accurate usage logs are maintained.

Failure to replace a target before it becomes too thin at any location can result in loss of control of sputtered material composition, for example, when the target is fully eroded at some location and further erosion comes from a backing plate. In more extreme examples, catastrophic system failure due to loss of high vacuum can occur. Typically, sputtering targets require liquid cooling to prevent melting of target material, and erosion that thins the target to the point where a rupture between the coolant supply and the high vacuum occurs can seriously damage the vacuum system.

Good practice requires periodic monitoring of the target thickness. Such monitoring is commonly performed by removing the target from the sputtering source, measuring the thickness profile in an external instrument, and returning the target to the sputtering source. However, this is a time-consuming process, because the high vacuum system must be opened to remove, measure, and replace the target. Restoring the high vacuum typically requires a lengthy pump-down and heating cycle to fully degas the inside of the vacuum system. Complete cycle time can be at least a day, and productivity can be lost.

What is needed is a means of measuring the target thickness in situ without breaking the high vacuum.

### SUMMARY OF THE INVENTION

Methods and systems for in situ measuring sputtering target erosion are disclosed. The emission of material from the sputtering target is stopped, a distance sensor is scanned across a radial line on the sputtering target, and the resulting distance data is converted into a surface profile of the sputtering target. The sputtering chamber contains a controlled environment separate and distinct from the environment outside the chamber, and the controlled environment is maintained during the scanning. The distance sensor can be a reflective optical distance sensor. The accuracy of the surface profile can be less than about ±1 μm. The distance sensor is protected from deposition of the material from the sputtering target. End-of-life for a sputtering target can be determined by obtaining a surface profile of the sputtering target at regular intervals and replacing the sputtering target when the thinnest location on the target as measured by the surface profile is below a predetermined threshold.

Deposition on a substrate can be monitored by obtaining a plurality of surface profiles of a sputtering target before and after sputtering under predetermined conditions for a predetermined time, and calculating from the plurality of surface profiles the volume of material eroded from the sputtering target during sputtering. The amount of material deposited on a substrate can be obtained by comparing the volume of material eroded to a calibration comprising correlating the volume of material eroded to another measure of deposition rate.

The distance sensor can be scanned across a line along the sputtering target to create a two-dimensional surface profile of the sputtering target. Typically, with a round target, the distance sensor is used to scan a radial line across the target. The distance sensor can also be scanned across an area of the sputtering target to create a three-dimensional surface profile of the sputtering target. The uniformity of erosion of a sputtering target can be monitored by obtaining a three-dimensional surface profile of the sputtering target, and analyzing the surface profile of the sputtering target to identify areas of increased or decreased erosion compared to surrounding areas.

A sputtering system is disclosed including a sputtering target and a distance sensor. The sputtering target and the distance sensor are disposed in a sputtering chamber that is operable to deposit material on a substrate, and the distance sensor is protected from material deposition during sputtering. The sputtering chamber contains a controlled environment separate and distinct from the environment outside the chamber, and the controlled environment is maintained during operation of the distance sensor. The distance sensor is operable to obtain a surface profile of the sputtering target across the target surface, and the surface profile can be obtained without changing the pressure or gas composition in the sputtering chamber. The distance sensor can be operable to obtain a two-dimensional surface profile or a three-dimensional surface profile of the sputtering target. The distance sensor can be a reflective optical distance sensor.

The accuracy of the surface profile can be less than about ±1 μm. The surface profile of the sputtering target can be obtained at regular intervals, and the sputtering target can be replaced when the thinnest location on the target as measured by the surface profile is below a predetermined threshold.

The volume of material eroded from the sputtering target during sputtering under predetermined conditions for a predetermined time can be calculated from surface profiles measured before and after sputtering. The amount of material deposited on a substrate can be determined by comparing the volume of material eroded to a calibration correlating the volume of material eroded to another measure of deposition on a substrate, such as a thickness monitor.

### BRIEF DESCRIPTION OF THE DRAWINGS

FIG. 1 shows an example measurement of the surface profile of a target.

### DETAILED DESCRIPTION

It must be noted that as used herein and in the claims, the singular forms “a,” “and” and “the” include plural referents unless the context clearly dictates otherwise. Thus, for example, reference to “a target” includes two or more targets, and so forth.

Where a range of values is provided, it is understood that each intervening value, to the tenth of the unit of the lower limit unless the context clearly dictates otherwise, between the upper and lower limit of that range, and any other stated or intervening value in that stated range, is encompassed within the invention. The upper and lower limits of these smaller ranges may independently be included in the smaller ranges, and are also encompassed within the invention, subject to any specifically excluded limit in the stated range. Where the stated range includes one or both of the limits, ranges excluding either or both of those included limits are also included in the invention. The terms “about” and “approximately” generally refers to ±10% of a stated value. The term “substantially” refers to ±5% of a stated value.

### Definition

As used herein, the term “surface profile” generally refers to a two- or three-dimensional representation illustrating the position of points on a surface. For example, if the z-axis is normal to a surface, then a plot of z vs. x for selected points on a surface can represent a two-dimensional surface profile, and a plot of z vs. x and y for selected points on a surface can represent a three dimensional surface profile.

Embodiments of the present invention provide systems and methods for measuring the surface profile of a sputtering target in situ, i.e., the measurement can be performed in the sputtering chamber having a controlled environment. The measurement can be performed irrespective of the environmental conditions in the sputtering chamber, and the composition or pressure of the atmosphere in the sputtering chamber can be maintained constant or varied as desired.

Sputtering targets are widely used for deposition of a wide variety of materials in semiconductor processing. However, if targets are allowed to become too thin, there is a danger of catastrophic damage to sputtering systems. Therefore, monitoring the remaining thickness of targets is important so that targets can be replaced before they become too thin. In addition, monitoring the change of thickness within shorter time frames can also be useful as a cross-check on material deposition rates and system performance. For these latter purposes, more precise measurements may be required.

Accordingly, methods for in situ measuring sputtering target erosion comprise stopping the emission of material from a sputtering target disposed in a sputtering system, scanning a distance sensor across the sputtering target, and converting the resulting distance data into a surface profile of the sputtering target. The sputtering chamber contains a controlled environment separate and distinct from the environment outside the chamber, and the controlled environment is maintained during the scanning, i.e., the scanning can be performed while controlling the pressure or gas composition in the sputtering chamber, and without opening the chamber to the outside environment. The controlled environment in the sputtering chamber during scanning can be substantially the same as the controlled environment in the sputtering chamber during sputtering, or it can be changed if desired. Gas flows are used during sputtering to create either an inert atmosphere or a reactive atmosphere. These gas flows can be left on during scanning, or they can be turned off. Accordingly, there is no need to open the sputtering chamber to the atmosphere outside the sputtering chamber to perform the scanning step, and sputtering can be immediately resumed once scanning is complete and the distance sensor has been retracted away from the vicinity of the target.

If desired, the gas composition and/or pressure can be changed during scanning, for example, by removing any reactive gases, but maintaining an inert gas flow such as argon. Gas flow rates can also be reduced or increased but not completely turned off. The gases present during scanning can comprise any carrier gas, reactive gas, or purge gas available for use during sputtering and maintenance operations. The gas pressure can typically be maintained constant during scanning at any convenient pressure, for example, between 1 mTorr and 900 Torr. In some embodiments, all gas flows are disabled and scanning is performed in a vacuum environment.

The sputtering chamber environment is controlled to prevent the introduction of contaminant molecules from sources outside the sputtering system. Specific contaminants that are excluded from the system include gases from the environment outside the sputtering chamber and molecules that can outgas from any surface of the distance sensor or any of its mounting hardware or scanning mechanisms. Typically, the distance sensor and its mounting hardware and scanning mechanisms are continuously exposed to the sputtering chamber environment, although these components are generally shielded from direct exposure to sputtered material while sputtering is in progress.

The resulting distance data is converted into a surface profile of the sputtering target. The accuracy of the surface profile can be less than about ±1 μm. The distance sensor can be scanned across a line along the sputtering target to create a two-dimensional surface profile of the sputtering target. The distance sensor can also be scanned across an area of the sputtering target to create a three-dimensional surface profile of the sputtering target. The distance sensor can be a reflective optical distance sensor.

A typical sputtering target comprises an approximately 6 mm thick round disk of target material (comprising metals, alloys, oxides, nitrides, etc.) soldered to a water-cooled Cu/Ti backing plate. Other sputtering targets can be rectangular or cylindrical. Target diameters can vary widely. Targets can be stationary or rotating. In some systems, a single larger diameter target is used for deposition of a single material onto a large substrate. In other systems, a plurality of sputtering sources is provided, each with a separate sputtering target whose composition can vary. Sputtering sources commonly use a suitably high-energy plasma to sputter material from the target. A magnetron is typically used to direct ions to the target surface, and the resulting erosion pattern is ring-shaped, although other erosion patterns can also occur, and some sputtering sources use complex moving magnet assemblies designed to achieve more uniform erosion. For the typical stationary magnetron, the erosion generally exhibits rotational symmetry (independent of angle in polar coordinates), forming an erosion groove in the target. In some embodiments, it is sufficient to measure erosion along a radial line across the target, perpendicular to the erosion groove.

The distance sensor is protected from deposition of the material from the sputtering target. In some embodiments, the measurement can be performed intermittently when sputtering is disabled (i.e., the plasma generator is turned off). In some embodiments, during active sputtering, the measurement system can be fully retracted so that no portion of the measurement system interferes with deposition, and in the retracted position, the measurement system is shielded so that no sputtered material is deposited onto the portions of the distance sensor that are involved with measuring the target profile. If desired, the distance sensor can be shielded in a sealed compartment until deployed for use. For example, when the distance sensor is a reflective optical distance sensor, the portions of the sensor irradiating the target with light or receiving or sensing reflected light from the target are protected from deposited material. When sputtering is stopped or disabled, the measurement system is operable to scan along the surface of the sputtering target to obtain a surface profile.

Deposition on a substrate can be monitored by obtaining surface profiles of a sputtering target before and after sputtering under predetermined conditions for a predetermined time, and calculating from the surface profiles the volume of material eroded from the sputtering target during sputtering. The amount of material deposited on a substrate can be obtained by comparing the volume of material eroded to a calibration comprising correlating the volume of material eroded to another measure of deposition rate. For example, the thickness of a deposited layer on a substrate can be determined after a predetermined period of sputtering. The surface profiles obtained before and after the sputtering was performed can be used to calculate the amount of material removed from the sputtering target during this time period, and this amount can be correlated with the volume of material deposited on the substrate, to serve as a measure of the deposition rate onto a substrate, and to indicate the efficiency of deposition (how much material actually arrives at the substrate). Once the correlation is established, the target erosion can be used as a measure of material deposition on the substrate.

The surface profile can be used to monitor target thickness as a function of use, for example to determine end of useful life. End-of-life for a sputtering target can be determined by obtaining a surface profile of the sputtering target at regular intervals and replacing the sputtering target when the thinnest location on the target as measured by the surface profile is below a predetermined threshold. Measurement as a function of position can also provide other useful information about the uniformity and distribution of target erosion. For example, the uniformity of erosion of a sputtering target can be monitored by obtaining a three-dimensional surface profile of the sputtering target, and analyzing the surface profile of the sputtering target to identify areas of increased or decreased erosion compared to surrounding areas. Polycrystalline targets can show such areas of variable erosion. Mosaic targets having composition variations across the surface can also exhibit variabilities in erosion. By measuring a three-dimensional surface profile, the erosion uniformity or nonuniformity of the varying target materials can be assessed.

Sputtering systems are also disclosed. The sputtering systems comprise a sputtering target and a distance sensor. The sputtering target and the distance sensor are disposed in a sputtering chamber that is operable to deposit material on a substrate. The distance sensor can be a reflective optical distance sensor. The sputtering chamber contains a controlled environment separate and distinct from the environment outside the chamber, and the controlled environment is maintained during the scanning, i.e., the scanning can be performed while controlling the pressure or gas composition in the sputtering chamber, and without opening the chamber to the outside environment.

The system can further comprise a shield operable to protect the distance sensor from material deposition during sputtering. For example, the distance sensor can be removed from the path of sputtered material by placing it behind a shield. An optional shutter can be provided to fully enclose a region where the sensor can be positioned during active sputtering. If desired, the distance sensor can be shielded in a sealed compartment until deployed for use. The distance sensor is operable to obtain a surface profile of the sputtering target across the target surface, and the surface profile can be obtained without changing the pressure or gas composition in the sputtering chamber. The distance sensor can be operable to obtain a two-dimensional surface profile or a three-dimensional surface profile of the sputtering target.

Various measurement technologies can be used to obtain the surface profile as long as the active measurement point can be scanned along surface of the sputtering target. Non-contact methods are preferred, so that no alteration or damage to the sputtering target occurs as a result of measurement. Example methods include mechanical, ultrasonic, radar, inductive, capacitive, interferometry, and optical displacement. For example, the sensor techniques used in various non-contact position sensors manufactured by the Keyence Corporation and MTI Instruments Inc. can be used. The sensor system components inside the vacuum environment can be selected to be compatible with maintaining high-vacuum, as well as space constraints in the volume between the sputtering target and a deposition substrate. Outer surfaces of the measurement system within the vacuum environment can be made from materials that do not outgas significantly or which can be degassed by standard methods such as heating. Any motion control from outside the vacuum environment can be made through suitable high-vacuum seals such as ferro-fluidic seals.

In an exemplary embodiment, the distance sensor is a reflective optical distance sensor having fiber optic light delivery and collection, such as the MTI-2100 Fotonic Sensor (MTI Instruments Inc., Albany, N.Y.). The sensor can be physically scanned across the target surface (e.g., along a radial line) using a translation mechanism located outside the vacuum environment. When not actively measuring a sputtering target, the sensor can be fully retracted into a location where it is protected from sputtered material during active sputtering. An optional shutter can be used to isolate the retracted sensing head from sputtered material.

Typically, the outer edge of a sputtering target is outside the plasma region and does not erode appreciably during use. Therefore, the location of this edge or another fixed non-erodible surface within the scan range can be used as a zero-reference corresponding to the distance between the sensor and the target for the condition of no erosion or for a new target. In some cases, the center of the target also experiences little or no erosion, and measurements at the center and edge can define a zero-reference line to which all other measurements can be referenced by subtraction. Alternatively, a zero reference line can be established by measurement of a new target prior to first use. In some embodiments, the scan direction is not exactly perpendicular to the target normal, and measurements of the reference line are important to establish the deviation from perpendicularity. Even small deviations can be important if the measurement is used to monitor the quantity of material eroded in one or a small number of process runs.

In some embodiments, one or more sputtering sources (and their associated sputtering targets) can be positioned at an angle with respect to the normal to the substrate on which material is to be deposited, for example as described in U.S. patent application Ser. Nos. 13/313,275 filed on Dec. 7, 2011, 13/339,648, filed on Dec. 29, 2011, and 13/444,100, filed on Apr. 11, 2012, each of which are herein incorporated by reference for all purposes. In some embodiments, a plurality of sputtering sources (and their associated sputtering targets) can be positioned in a sputtering chamber to sputter a plurality of target materials on a substrate. In these embodiments, practical space constraints may limit the access of the sensor to the target. For example, the scan direction may be perpendicular to the substrate normal rather than the sputtering target normal. A suitable reflecting surface (mirror or prism) can be used to direct the light substantially parallel to the sputtering target normal.

In some embodiments, light deflection via a scanning reflector can be used instead of, or in addition to, a translation mechanism to scan a measurement spot over a sputtering target surface. Further variations in translation and scanning mechanisms can be used as are well known in the art. For example, in some embodiments, a measurement spot can be scanned in two dimensions instead of one to provide a three-dimensional surface profile of a sputtering target. Scanning can be in Cartesian (x-y) coordinates or polar (r-θ) coordinates, and scan order can be arbitrary to suit the convenience of the scanning mechanism. Such embodiments can be useful, for example, with mixed material, polycrystalline, or mosaic sputtering targets which can exhibit differential sputtering rates for the different materials or grains (and hence measure pitting or surface irregularities) across the area of a target. In some embodiments, the target itself can be rotated about its axis, and this rotation can provide an angular dimension for polar coordinates.

In situ sputtering target measurement can be implemented with any sputtering target including targets made from metals, oxides, nitrides, oxynitrides, silicides, semiconductors, and other compounds and alloys. The measurement can be used for various purposes, depending on the use to which a particular sputtering source is applied. In some embodiments, the measurement can be performed infrequently to determine end-of-life for a particular target and to schedule replacement. Replacing a target is a time-consuming process requiring opening the vacuum chamber and replacing the target, followed by a slow pump-down and outgassing cycle to restore the high vacuum environment, necessitating significant down time for the sputtering system. Targets can be expensive as well, and users generally do not want to replace targets which still have useful life. At the same time, waiting too long to replace a target can risk through-erosion with serious consequences: sputtering of backing plate material, erosion into cooling lines, catastrophic vacuum system failure, and the like.

Advantageously, the methods provide improved throughput and productivity in both production and R & D applications. The in situ measurement can be performed and deposition can be immediately resumed without the need for outgassing the chamber. For example, the measurement can be performed, and if the sputtering target does not show excessive erosion, the deposition can be continued without delay necessitated by opening the chamber to the external environment to replace the target. A typical scan can be performed in a few seconds to a few minutes, and the total downtime can be only slightly longer than the scan time.

In situ sputtering target measurement can also be used as part of experimental protocols. In some embodiments, the measurement accuracy for the measured surface profile is about ±1 μm, and it is possible to calculate accurate estimates of the volume of material sputtered during a single sputtering event by comparing the surface profile before and after sputtering. The measurement of erosion rate can be compared to and correlated with other measurements of material deposition such as thickness monitors for deposited layers. This comparison can be used both to monitor the sputtering process to make sure that the sputtering source is operating at the desired material delivery rate as well as to provide an auxiliary method to monitor the amount of deposited material. Other undesirable events such as target melting or pitting (either in localized spots or over larger areas) can also be detected as unexpected changes in the surface profile.

### EXAMPLE

### Measurement of the Depth of an Erosion Groove on a Sputtering Target

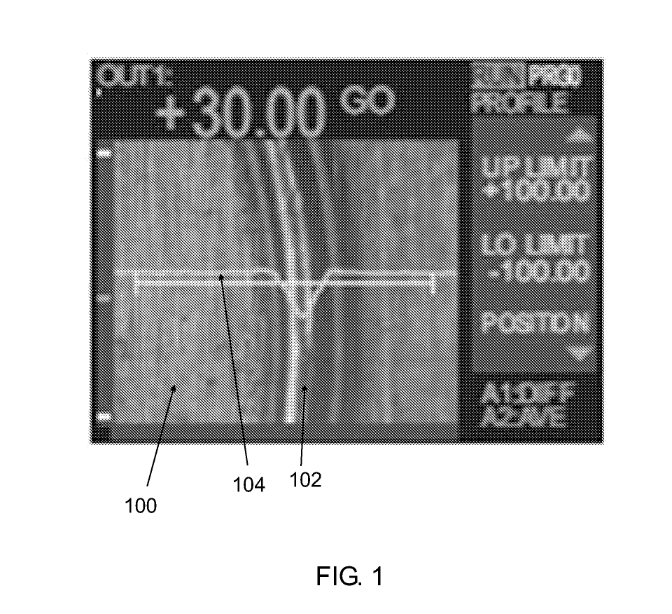

A surface profile was obtained on a round sputtering target, a portion of which is depicted in the photograph shown in FIG. 1. A circular erosion groove 102 can be seen in target 100, which is a used Ti target. The target was removed from the vacuum system and measured on a lab bench. A surface profile was measured along a portion of a radial line (perpendicular to the circular erosion groove 102) using a depth gauge (Mitutoyo 547-218S from Mitutoyo America, Aurora, Ill.). The surface profile 104 is shown superimposed on the photograph, and the dip in the surface profile is seen to coincide with the erosion groove 102. The depth of the erosion groove was found to be ˜40 μm.

It will be understood that the descriptions of one or more embodiments of the present invention do not limit the various alternative, modified and equivalent embodiments which may be included within the spirit and scope of the present invention as defined by the appended claims. Furthermore, in the detailed description above, numerous specific details are set forth to provide an understanding of various embodiments of the present invention. However, one or more embodiments of the present invention may be practiced without these specific details. In other instances, well known methods, procedures, and components have not been described in detail so as not to unnecessarily obscure aspects of the present embodiments.

What is claimed is:

1. A method of in situ measurement of sputtering target erosion comprising
scanning a distance sensor across a sputtering target in a sputtering chamber, and
converting the resulting distance data into a surface profile of the sputtering target,
wherein the sputtering target and the distance sensor are disposed in the sputtering chamber,
wherein the sputtering chamber contains a controlled environment separate and distinct from the environment outside the chamber, and
wherein the controlled environment is maintained during the scanning.

2. The method of claim 1, wherein the sputtering process is stopped while the scanning is performed.

3. The method of claim 1, wherein the scanning is across a line on the sputtering target.

4. The method of claim 3, wherein the line is a radial line perpendicular to a circular erosion groove.

5. The method of claim 1, wherein the accuracy of the surface profile is less than about ±1 μm.

6. The method of claim 1, wherein the distance sensor is protected from deposition of the material from the sputtering target.

7. The method of claim 1, wherein the distance sensor is a reflective optical distance sensor.

8. A method of determining end-of-life for a sputtering target comprising
obtaining a surface profile of the sputtering target by the method of claim 1 at regular intervals, and
replacing the sputtering target when a thinnest location on the target as measured by the surface profile is below a predetermined threshold.

9. A method of monitoring deposition on a substrate comprising
obtaining a plurality of surface profiles of a sputtering target by the method of claim 1 before and after sputtering under predetermined conditions for a predetermined time,
calculating from the plurality of surface profiles a volume of material eroded from the sputtering target during sputtering, and
determining an amount of material deposited on a substrate by comparing the volume of material eroded to a calibration comprising correlating the volume of material eroded to another measure of deposition rate.

10. The method of claim 1, further comprising scanning the distance sensor across an area of the sputtering target to create a three-dimensional surface profile of the sputtering target.

11. A method of monitoring the uniformity of erosion of a sputtering target comprising
obtaining a three-dimensional surface profile of the sputtering target by the method of claim 10,
analyzing the surface profile of the sputtering target to identify areas of increased or decreased erosion compared to surrounding areas.

12. A sputtering system comprising
a sputtering target, and
a distance sensor;
wherein the sputtering target and the distance sensor are disposed in a sputtering chamber,
wherein the distance sensor is operable to obtain a surface profile of the sputtering target,
wherein the sputtering chamber contains a controlled environment separate and distinct from the environment outside the chamber, and
wherein the controlled environment is maintained during operation of the distance sensor.

13. The sputtering system of claim 12, wherein the distance sensor is a reflective optical distance sensor.

14. The sputtering system of claim 12, further comprising a shield operable to protect the distance sensor from material deposition during sputtering.

15. The sputtering system of claim 12, wherein the accuracy of the surface profile is less than about ±1 μm.

16. The sputtering system of claim 12, wherein the distance sensor is operable to obtain a two-dimensional surface profile of the sputtering target.

17. The sputtering system of claim 12, wherein the distance sensor is operable to obtain a three-dimensional surface profile of the sputtering target.
